(19) United States
(12) Patent Application Publication
(10) Pub. No.: US 2010/0183363 A1
(43) Pub. Date: Jul. 22, 2010

(54) CABLE SCREW CONNECTION HAVING A COUNTER SLEEVE OR UNION NUT

(75) Inventors: Mario Bartholoma, Winden (DE); Fritz Zugel, Waldkirch (DE); Volker Gotz, Kenzingen (DE); Philipp Gerber, Gutach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ANTON HUMMEL VERWALTUNGS -- GMBH, Waldkirch (DE)

(21) Appl. No.: 12/530,068

(22) PCT Filed: Feb. 2, 2008
(86) PCT No.: PCT/EP08/00843

§ 371 Date: Feb. 18, 2010

(30) Foreign Application Priority Data
Mar. 9, 2007 (DE) 20 2007 003 513.6

(51) Int. Cl. F16L 41/00

(52) U.S. Cl. 403/259

(57) ABSTRACT

A threaded cable connection (1) that can be attached via a threaded sleeve (4) thereof and a coupling nut (6), and also with a clamping insert disposed on the inside, and a cable (7), to an opening (2) in a wall (3) of a housing, and which can be protected and enclosed on the outside of the wall (3) with the aid of a protective cover (10). The cover is also sealed in relation to the cable (7).

### BACKGROUND

The invention relates to a threaded cable connection with a threaded sleeve that can be inserted into an opening of a wall or a housing, a counter sleeve or a union nut that can be connected thereto via a thread, and a clamping insert that can be pressed against the cable or a protective hose to be screwed tight or to be fixed by a thread connecting the threaded sleeve to the counter sleeve or union nut, with the threaded sleeve, in addition to the thread for the counter sleeve or the union nut, having a fastening means, for example a fastening thread, which fits into a counter thread of the opening of the wall or a nut located behind the wall, with the threaded sleeve additionally being provided with a flange, particularly having an exterior polygon or hexagon, that can be pressed against the edge of the opening of the wall by fastening or tightening the fastening thread.

Such a threaded cable connection with a clamping insert, connected to the threaded sleeve in one piece, is known for example from DE-GM 77 14 231 and from U.S. Pat. No. 5,927,892, which shows a separate clamping insert.

Comparable threaded cable connections are also known from DE 21 32 951 C3 or from EP 0 203 268 B1 and have proven.

However, there are applications in which it is disadvantageous that the exterior of the threaded cable connection can be contaminated, particularly by environmental influences, and is hard to clean. Furthermore, it is possible that such a threaded cable connection fails to sufficiently meet the requirements of tightness, for example in the field of clean rooms, because due to the thread between the threaded sleeve and the counter sleeve or union nut, an entire impermeability can not be achieved.

### SUMMARY

Therefore, the object is to provide a threaded cable connection of the type mentioned at the outset in which the need for cleaning, for example of the thread of the threaded sleeve located outside the threaded sleeve or the union nut, can be largely avoided.

In order to attain this object the threaded cable connection defined at the outset is characterized in that a covering cap, overlapping a part of the threaded cable connection located at the wall and sealing it in the operating position at the wall, is provided with a penetrating opening for the cable, with the penetrating opening and the cable being sealed in reference to each other in the operating position.

Such a covering cap can prevent the entry of contaminants to the screw cable connection and particularly to the actually exposed threaded section of the threaded sleeve and for the rest also protect the part of the threaded cable connection projecting from the wall or being located at its outside from mechanical interference or aggressive media and vapors. Furthermore, any unauthorized manipulation of the threaded cable connection can be at least aggravated because it is hidden underneath the covering cap.

Here, it is particularly beneficial when the covering cap is made from metal or plastic and is axially fixed in reference to the threaded cable connection in its operating position. Then it also withstands attempts to simply lift it off and pull it off the threaded cable connection.

Here, in the operating position the covering cap can be connected to the threaded cable connection in a detachable and axially fixed fashion. Thus it remains accessible for the purpose of repairing the threaded cable connection.

A particularly beneficial embodiment of the threaded cable connection according to the invention may comprise, here, that the covering cap with the threaded cable connection is provided with a threaded connection embodied as a detachable, axially effective mutual fastening. This represents not only an effective fastening of the covering cap in the operating position but it also results in a simple way of assembly and disassembly.

Here, it is particularly beneficial for a simple production and assembly when the covering cap is provided with an internal thread which in the operating position matches an external thread arranged on the threaded cable connection such that after the assembly of the threaded cable connection, the covering cap can be screwed thereto at its outside and via said threaded connection can be pressed against the wall penetrated by the threaded cable connection. The threaded cable connection can therefore be assembled in a conventional fashion, with the covering cap, already placed over the cable, is pushed onto the threaded cable connection and is then screwed tightly onto it by way of rotation.

A preferred arrangement may comprise here that the external thread at the threaded sleeve matching the internal thread of the covering cap and cooperating therewith is arranged, particularly at the flange or polygon or hexagon of the threaded sleeve and/or at the threaded part or threaded ring carrying an external thread which is supported on the flange or hexagon of the screw connection.

Therefore there are various ways to provide this counter thread for the covering cap. When it is provided immediately at the flange or polygon or hexagon of the threaded sleeve no additional part is necessary therefore. However, when it is provided in the form of a threaded part or threaded ring, which then can be supported on the flange or polygon, the advantage develops that already existing threaded cable connections can be retrofitted with it.

The threaded part provided with the external thread can beneficially be embodied as a threaded ring, with its interior recesses showing a larger diameter in reference to the exterior diameter of a fastening thread or fastening socket at the threaded sleeve. This way, the threaded ring can be pushed onto the fastening socket of the threaded sleeve and then be fastened here in a conventional manner, for example at a housing wall, which simultaneously fixes the threaded ring, too, and then it can be used for screwing on the covering cap.

Here, the interior diameter of the threaded ring may have such a size that it fits over fastening threads of various sizes. For example, it may be embodied such that it can accept fastening threads at the fastening socket of the threaded sleeve having slightly different sizes so that threaded sleeves with metric threads or threads measured in inches et cetera can each be equipped with the same threaded ring as long as they can be arranged concentrically in reference to the threaded sleeve and projecting beyond the flange of the hexagon in order to allow serving as counter threads for the covering cap.

In the operating position the threaded ring can here be clamped between the flange or the hexagon of the threaded sleeve and a housing wall due to the fastening of the threaded sleeve so that in order to allow a screw connection no additional measures are necessary when mounting the covering cap.

In the alternative, in which the threads matching the internal thread of the covering cap are provided at the polygon or the hexagon of the threaded sleeve, it is possible that said threads can be arranged at the polygon or the hexagon of the threaded sleeve in its respectively rounded edge areas and thus each be interrupted in their perimeters by the flat sections of the polygon or hexagon.

Therefore it is unnecessary to provide any additional threaded section at the threaded sleeve, rather the polygon or hexagon in the operating position abutting the wall in the form of a flange can also serve to tighten the fastening thread of the threaded sleeve, may show the threaded sections at its rounded edge regions matching the internal thread of the threaded sleeve and allow it to be screwed upon the threaded cable connection to a tight contact at the counter sealing surface, particularly in the area of the wall located around the threaded sleeve.

Here, for a good seal it is beneficial when the penetrating opening of the covering cap for the cable or a protective hose and the cable guided through it or a protective hose have little tolerance in reference to each other, particularly have a sealing push fit or clamping fit. During the assembly, the cable or the protective hose already penetrates the penetrating opening of the covering cap, which then after the assembly of the threaded cable connection and the fixation of the cable is pushed along the cable towards the threaded cable connection and can be fixed in the operating position. Here, the sealing push fit or clamping fit between the cable or protective hose and the covering cap remains so that the penetrating opening of the covering cap is also sealed in the operating position.

Due to the fact that generally cable or protective hoses have a relatively elastic exterior, the sealing effect can already be achieved by this property. However, it is particularly beneficial when a gasket made from a flexible sealing material is arranged at the penetrating opening of the covering cap for the cable, with its opening being smaller than the cross-section of the cable and then said gasket then can be deformed, bulged and/or stretched in the area of the penetrating opening by the cable that is passed through. This can improve the sealing effect and furthermore cables of different cross-sections can be guided through such an elastic gasket tightly contacting the cable due to the flexibility of its material.

An additional or other measure for adjusting the covering cap to cables of different cross-sections may comprise that at its penetrating opening for the cable the covering cap is provided with at least one pre-determined breaking point, particularly arranged concentrically in reference to the penetrating opening, and that the penetrating opening can be enlarged by breaking out a part or a circular piece around the penetrating opening, with the covering cap preferably being made from plastic. Such a predetermined breaking point can be formed by a reduction of the material thickness, which is tight, though, so that the covering cap remains tight for a thinner cable when the parts remain, that can be broken out by breaking at the integrated predetermined breaking points.

The corner measures of an exterior polygon or hexagon located at the counter sleeve or union nut may be smaller than the ones of the flange of the threaded sleeve provided with an external thread. This way it is achieved that the covering cap with its internal thread can be pushed over the counter sleeve or union nut without the internal thread of the covering cap matching the external thread of the flange of the threaded sleeve colliding with the exterior polygon or exterior hexagon of the union nut. Here, it is particularly beneficial when the corner section of the exterior polygon or exterior hexagon of the union nut are flattened or, particularly by way of cutting, have been reduced and these flat sections of said polygon or hexagon now match the same wrench size as the flange of the threaded sleeve. This way, the threaded sleeve, on the one hand, and its counter sleeve or union nut, on the other hand, can be tightened with the same tool or wrench, yet the covering cap still can be pushed on and fastened without any problems.

For sealing the covering cap well it is necessary that its face pointing away from the penetrating opening for the cable or the protective hose has an appropriate seal cooperating with such a seal or being connected to such a seal. This can be achieved in that the face of the covering cap pointing away from the penetrating opening is so large or enlarged in reference to the exterior of the covering cap that a seal can be placed at this enlarged face, particularly in a circular groove. By way of tightening the thread of the covering cap said cap is then pressed in the axial direction against the seal and/or with its gasket against the sealing area of the wall so that sealing against liquids or gases can also be achieved. In a covering cap made from plastic the seal can also be formed in one piece in the form of a bead.

Primarily in combinations of one or more of the above-described features and measures a threaded cable connection develops, which can be protected from contaminations and undesired environmental influences or also mechanical interferences, still allowing the threaded cable connection to be used in cases in which such a protection is unnecessary and the covering cap can be omitted.

For example, instead of a seal inserted in a circular groove, for example an O-ring, the gasket can also be connected to the face of the covering cap in one piece, depending on the material the covering cap is made of.

### BRIEF DESCRIPTION OF THE DRAWINGS

In the following, the exemplary embodiments of the invention are explained in greater detail using the drawing. Shown in a partially schematic illustration are:

FIG. 1 a threaded cable connection according to the invention in a partially exploded view and/or in a pre-assembled state, in which the threaded sleeve and the union nut with the clamping insert located therein have already been pre-assembled and are just prior to the insertion into the opening of a wall, with the cable already penetrating the covering cap according to the invention remaining to be inserted.

FIG. 2 the threaded cable connection according to FIG. 1 after the cable has been fixed and clamped tight and prior to mounting the covering cap displaceable along the cable,

FIG. 3 the final assembly position after the axial displacement of the covering cap into its operating position and after its fastening,

FIG. 4 an illustration according to FIG. 3 with a cable being thinner in reference to FIGS. 1 to 3,

FIG. 5 a schematically illustrated cross-sectional view of a covering cap with an internal thread near its face, with the face being enlarged and comprising a seal as well as a gasket in the form of a membrane gasket at the passage for the cable pointing away from the face,

FIG. 6 the detail marked by the dot-dash lined circle E in FIG. 5 in an enlarged scale, with the gasket for impinging the exterior of the cable in the operating position,

FIG. 7 the detail marked by the circle K in FIG. 5 with a seal inserted in a circular groove for sealing the covering cap in the operating position against the wall or the exterior of a housing,

FIG. 8 an illustration of a modified covering cap according to FIG. 5, in which in the area of the cable passage concentric predetermined breaking points are provided for adjusting the passage to the differently thick cables and with the seal located at the face being connected in one piece to the covering cap, with a separate seal similar to FIGS. 5 and 7 may also be provided, though,

FIG. 9 the detail E of FIG. 8 in an enlarged scale, with the predetermined breaking points in the area of the cable passage through the covering cap,

FIG. 10 the detail K in FIG. 8 in an enlarged scale, with a seal formed as a bead in one piece at the enlarged face of the covering cap,

FIG. 11 an illustration of a modified exemplary embodiment according to FIG. 1, in which a thread is provided matching the threaded socket of the threaded sleeve and having at its exterior an external thread to cooperate with an internal thread of the covering cap, and

FIG. 12 an illustration according to FIG. 2 of an exemplary embodiment according to FIG. 11, in which the threaded sleeve has already been mounted to a housing wall, with the threaded ring being clamped between its polygon and the housing wall, however with the covering cap not yet placed in the operating position and screwed tight.

### DETAILED DESCRIPTION OF THE PREFERRED EMBODIMENTS

In the following description of various exemplary embodiments the parts having identical functions are given identical reference characters, even if their shapes are modified.

A threaded cable connection, in its entirety marked 1, has a threaded sleeve 4 that can be inserted into an opening 2 of a wall 3 and/or a housing, a counter sleeve in the form of a union nut 6 that can be connected thereto via a thread 5, and a clamping insert, not shown in the drawing, positioned inside the threaded sleeve 4 and the union nut 6, which can be pressed against a cable 7 to be held by screwing the threaded sleeve 4 to the counter sleeve or the union nut 6, as known for example from EP 0 203 268 B1 and the publications cited there.

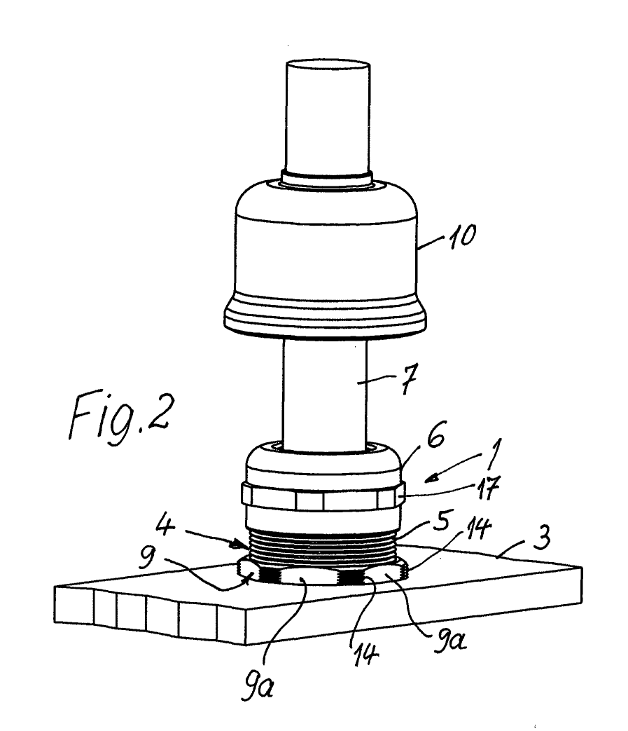

In addition to the thread 5, the threaded sleeve 4 has a fastening thread 8, which fits into a counter screw of the opening 2 of the wall 3 or a nut positioned behind the wall 3 such that the threaded sleeve 4 and/or the threaded cable connection 1 according to FIGS. 2 and 12 can be connected tightly but detachably to the wall 3. Here, it is discernible that the threaded sleeve 4 comprises a flange 9 that can be pressed against the edge of the opening 2 of the wall 3 by tightening the fastening thread 8, which in the exemplary embodiment is formed as an exterior polygon and/or exterior hexagon and thus allows the engagement of a wrench for said screw connection.

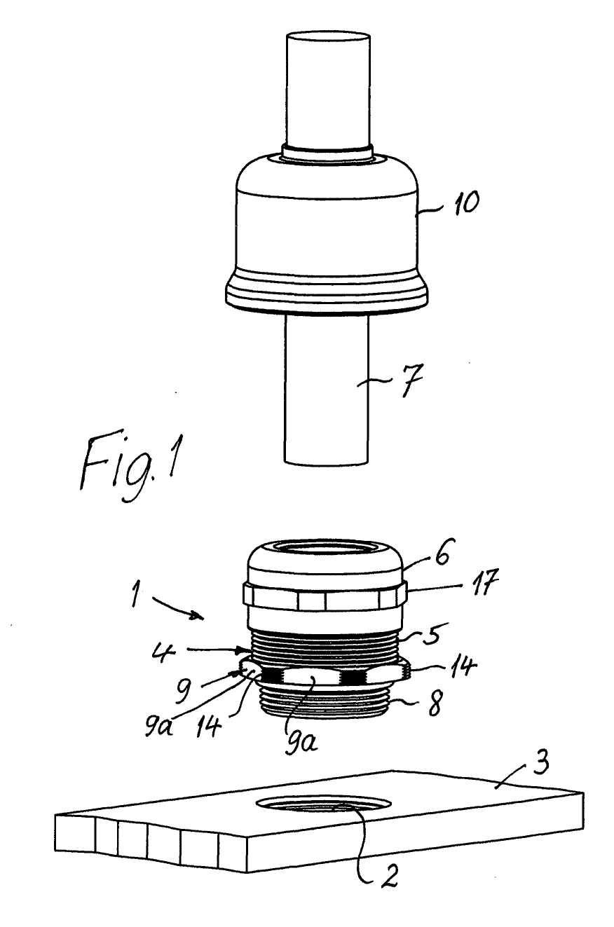

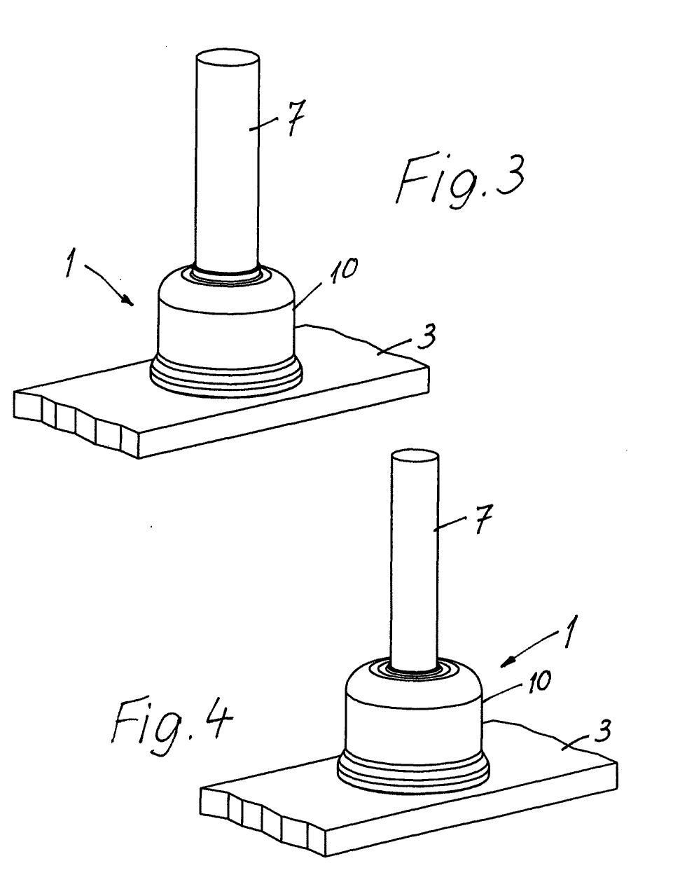

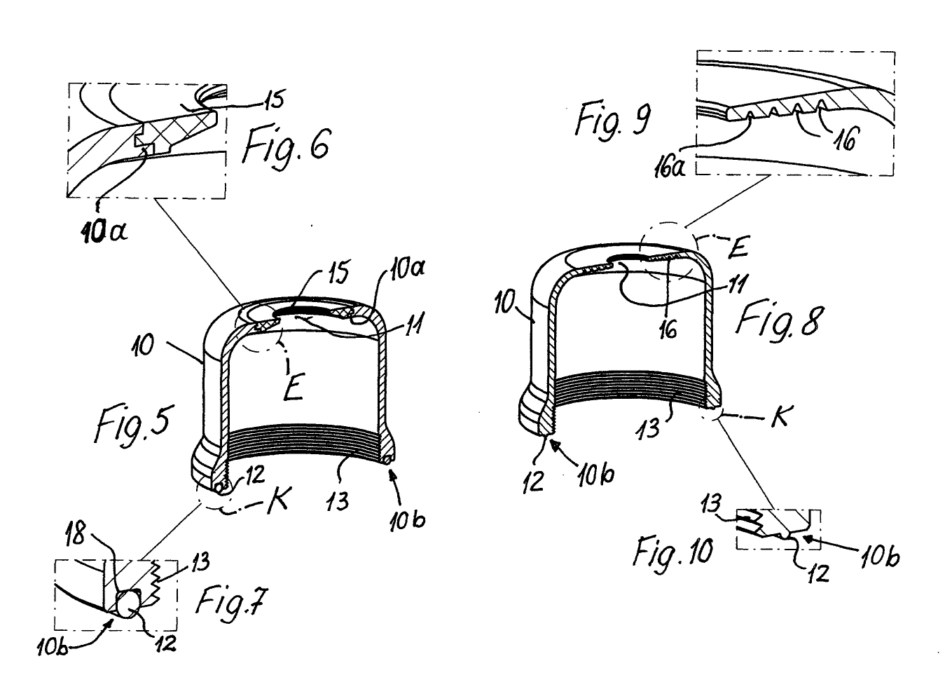

According to FIGS. 1 through 4, 11 and 12, here a covering cap 10 deviating from the exemplary embodiments of FIGS. 5 through 10 is shown in greater detail, which in the operating position (FIGS. 3 and 4) overlaps the part of the threaded cable connection 1 located at the wall 3 and protruding in reference to said wall 3 in the operating position according to FIG. 2. This covering cap 10 seals in its operating position to the wall 3 in a manner to be described in greater detail, and is provided with a penetrating opening 11 (cf. particularly FIGS. 5 and 8) for the cable 7, with in the operating position this penetrating opening 11 and the cable 7 being sealed in reference to each other such that with the help of said covering cap 10 the entire threaded cable connection 1 and also the cable 7 are covered and sealed. The degree of sealing can here be adjusted to the requirements and, supported by a facial seal 12 at the covering cap 10, which may be embodied as a gasket as in the exemplary embodiments, or if applicable without any.

The covering cap 10 may be made from metal or a hard or resistant plastic and in the operating position be axially fixed in reference to the threaded cable connection 1 and thus also in reference to the wall 3. For this purpose, in the exemplary embodiment the covering cap 10 is connected to the threaded cable connection 1 in a detachable and axially fixed fashion by way of a screw connection, which acts in the axial direction, but which can also be detached.

Primarily in FIGS. 5, 7, 8, and 10 it is discernible that the covering cap 10 near its face 10b pointing to the wall comprises an internal thread 13, which in the operating position matches an external thread 14 arranged at the threaded cable connection 1 such that the covering cap 10 after the assembly of the threaded cable connection 1 (FIGS. 2 and 12) can be screwed to its exterior and via said threaded connection can be pressed against the wall 3, which already leads to a sealing effect, even if no seal 12 is provided.

Here the external thread 14 cooperating with the internal thread 13 of the covering cap 10 is arranged in the exemplary embodiment according to FIGS. 1 and 2 at the threaded sleeve 4 and thus at the flange 9, i.e. at the exterior hexagon, with according to FIGS. 1 and 2 the threads of said external thread 14 being arranged at the rounded edge areas of said hexagonal flange 9 and thus in the circumferential direction are interrupted each by the flat sections 9a of said hexagonal flange 9. This way the flange 9 is given additional function and renders a special threaded section unnecessary at the threaded sleeve 4 for the covering cap 10.

For a mutual sealing of the covering cap 10 and the cable 7, the penetrating opening 11 of the covering cap 10 for the cable 7 and the cable 7 guided through it may have such a tight tolerance in reference to each other that this alone results in a tight push fit or clamping fit. Here, during the assembly the covering cap 10 according to FIG. 1 is already placed on the cable 7, i.e. the cable 7 penetrates the penetrating opening 11 before the cable 7 is fixed with the help of the threaded cable connection 1. When the cable 7 is fastened according to FIG. 2 with the help of the threaded cable connection 1 to the wall 3, the covering cap can now be displaced until it accepts the threaded cable connection 1 in its body and by way of being screwed thereto it reaches the sealed operating position.

Here, according to FIGS. 5 and 6 at this penetrating opening 11 of the covering cap 10 a membrane-like gasket 15 made from a flexible material can be arranged and connected to a respective holding edge 10a of the covering cap 10 in a form-fitting manner, with its passage being smaller than the cross-section of the cable 7. This gasket 15 can perhaps be deformed by the cable guided through in order to be bulged and/or stretched in the area of the penetrating opening 11 and thus also to allow cables 7 of different thicknesses.

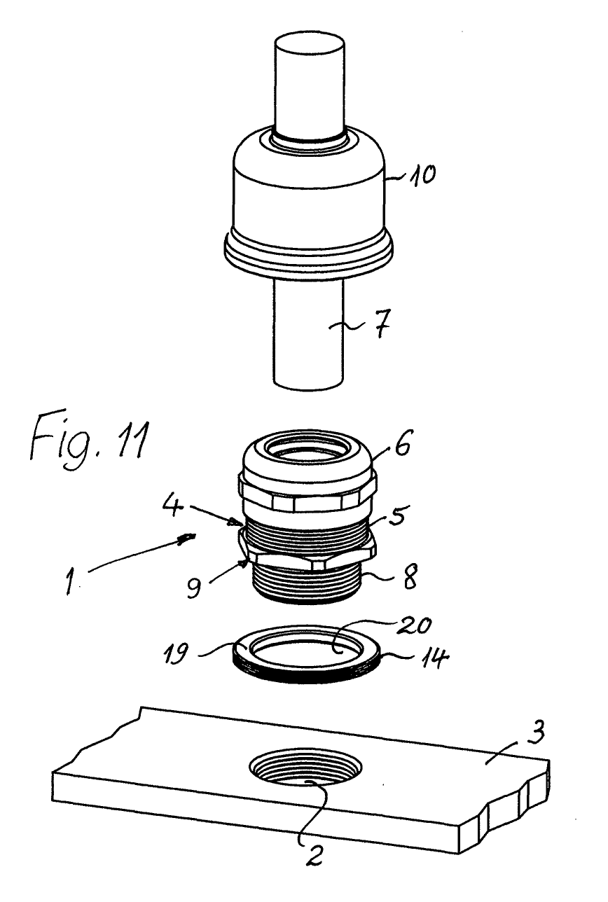

A modified arrangement and embodiment of the covering cap 10 is discernible in FIGS. 8 and 9. In this case, the covering cap 10 is provided with predetermined breaking points 16 at its penetrating opening 11 for the cable 7 arranged concentrically in reference to the penetrating opening 11 and the penetrating opening 11 can be enlarged by breaking out a portion or circular piece around the penetrating opening 11, with in this case the covering cap 10 is preferably made from plastic. In the arrangement shown a cable with a small cross-section can be engaged. When an interior ring is broken out at a predetermined breaking point 16a positioned next to a penetrating opening 11, a cable 7 of the next larger size may be used etc., with in the exemplary embodiment according to FIG. 9 four predetermined breaking points being provided, therefore five different cable diameters can be engaged.

It shall also be mentioned that the corner measures of an exterior polygon and/or hexagon 17 located at the counter sleeve or the union nut 6 is smaller than the one of the flange 9 of the threaded sleeve 4 provided with an external thread 14, so that the covering cap 10 adjusted with its interior cross-section and its internal thread 13 to said flange 9 can be pushed over said hexagon 17 without any problems and without colliding with it, however it may still show the same dimensions of the flat sections 9a so that for both hexagons the same tool or the same wrench can be used. It is sufficient to flatten or round the corner sections of the exterior polygon or hexagon 17 of the union nut even further or to reduce it by cutting so that the flat sections perhaps become shorter in the circumferential direction however retaining the same measurement as the ones of the flange 9 with regard to the wrench size.

It is discernible in FIGS. 5 and 7 as well as in FIGS. 8 and 10 that the face 10b of the covering cap 10 facing away from the penetrating opening 11 for the cable 7 is so large or the exterior of the covering cap 10 is enlarged such that a gasket 12 can fit at this enlarged face 10b.

Here, the seal 12 according to FIGS. 5 and 7 may be a gasket or an O-ring arranged in a circular groove 18, while according to FIGS. 8 and 10 the seal 12 may be connected in one piece to the face 10b of the covering cap 10.

Here, such one-piece seals 12 may also be combined with a flexible gasket 15 or a seal 12 placed in a circular groove 18 with a covering cap 10 having predetermined breaking points 16. However, the arrangement according to the illustrations in FIGS. 5 and 8 is beneficial, with FIG. 5 rather showing a covering cap 10 made from metal and FIG. 8 a covering cap 10 made from plastic, in which the sealing areas may be arranged in one piece.

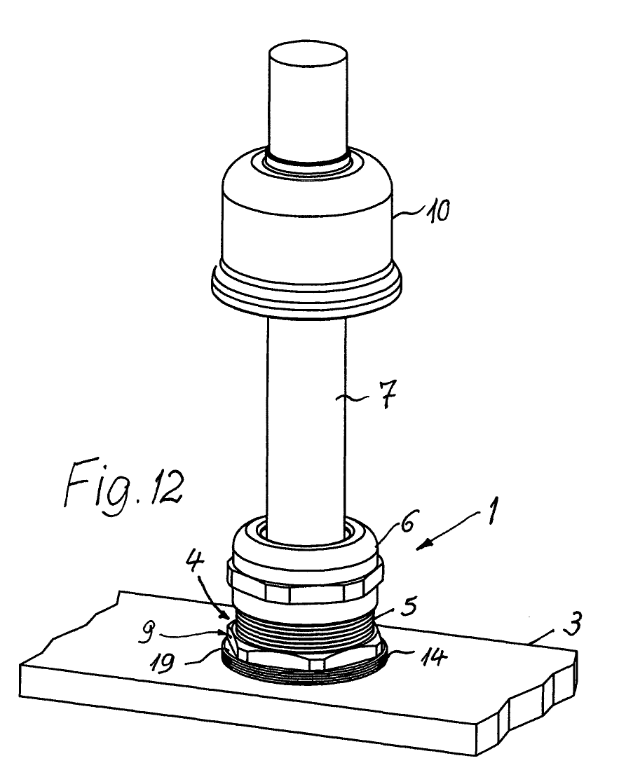

In FIGS. 11 and 12, a threaded cable connection 1 with a covering cap 10 is shown, which comprises the above-described features and is embodied in the same manner as shown in FIGS. 1 through 10.

However, in this case the external thread 14 cooperating with the internal thread 13 of the covering cap 10 is arranged at the threaded piece supported at the flange 9 or the hexagon of the threaded sleeve 4, which in the exemplary embodiment is embodied as a threaded ring 19, with its interior recess 20 having a greater diameter than the diameter equivalent to the fastening thread 8 or the fastening socket at the threaded sleeve 4. When comparing FIGS. 11 and 12 it is clearly discernible that the interior recess 20 of the threaded ring 19 is large enough to allow placement on the fastening socket with the fastening threads 8 of the threaded sleeve 4. This way, the threaded ring 19 can be penetrated when the threaded sleeve 4 is fastened at the wall 3 and pressed against the wall 3 by the flange 9 or the polygon, i.e. fixed, so that thereafter the covering cap 10 can be screwed onto the external thread of said threaded ring 19 because over the entire perimeter it radially projects beyond the flange 9 or the hexagon.

In FIG. 12 it is discernible how the threaded ring 19 is clamped in its operating position between the flange 9 or the hexagon of the threaded sleeve 4 and the housing wall 3, due to the fastening of the threaded sleeve 4.

Then, similar to the exemplary embodiment according to FIGS. 1 and 2, the covering cap 10 can be screwed to the thread of the threaded ring 19 such that an arrangement according to FIGS. 3 and 4 develops.

The threaded cable connection 1 can be mounted with its threaded sleeve 4 and a union nut 6 as well as a clamping insert arranged in its interior and a cable 7 at an opening 2 of a wall 3 of a housing and can be protected and enclosed at the exterior of the wall 3 with the help of a covering cap 10, also sealing in reference to the cable 7.

1. A threaded cable connection (1) comprising a threaded sleeve (4) that can be inserted into an opening (2) of a wall (3) or a housing, a counter sleeve or union nut (6) that is connectable thereto via threads (5), and a clamping insert, which can be pressed against a cable (7) or a protective hose by screwing the threaded sleeve (4) to the counter sleeve or the union nut (6), the threaded sleeve (4) in addition to the thread (5) for the counter sleeve of the union nut (6) also includes a fastening thread (8), which is adapted to fit into a counter thread in the opening (2) of the wall (3) or a nut located behind the wall (3), the threaded sleeve (4) additionally being provided with a flange (9) that can be pressed against an edge of the opening (2) of the wall (3) by fastening or tightening the fastening thread (8), a covering cap (10) with a penetrating opening (11) for the cable (7) is provided overlapping a part of the threaded cable connection (1) located at the wall (3), sealed in an operating position to the wall (3), with the penetrating opening (11) and the cable (7) being sealed in reference to each other in the operating position.

2. A threaded cable connection according to claim 1, wherein the covering cap (10) is made from metal or plastic and is axially fixed in the operating position in reference to the threaded cable connection (1).

3. A threaded cable connection according to claim 1 wherein in the operating position the covering cap (10) is connected to the threaded cable connection (1) in a detachable and axially fixed fashion.

4. A threaded cable connection according to claim 1, wherein the covering cap (10) includes a threaded connection for a detachable, axially effective connection to the part of the threaded cable connection.

5. A threaded cable connection according to claim 4, wherein the covering cap (10) comprises an internal thread (13), which in the operating position matches an external thread (14) arranged on the part of the threaded cable connection (1) such that the covering cap (10) after assembly of the threaded cable connection (1) can be screwed to it on an outside and can be pressed against the wall (3) via said threaded connection.

6. A threaded cable connection according to claim 5, wherein the external thread (14) cooperating with the internal thread (13) of the covering cap (10) is arranged on at least one of the flange (9) or a hexagon of the threaded sleeve or on a threaded part or threaded ring (19) carrying an external thread (14) supported on the flange (9) or hexagon of the threaded sleeve (4).

7. A threaded cable connection according to claim 6, wherein the threaded part provided with an external thread comprises the threaded ring (19), with an interior dimension (20) having a larger diameter than one equivalent to an exterior diameter of the fastening thread (8) or fastening socket of the threaded sleeve (4).

8. A threaded cable connection according to claim 7, wherein an interior diameter of the threaded ring has such a dimension that it fits over differently sized fastening threads.

9. A threaded cable connection according to claim 7, wherein in the operating position, the threaded ring (19) is clamped between the flange (9) or hexagon of the threaded sleeve (4) and a housing wall (3) due to fastening of the threaded sleeve (4).

10. A threaded cable connection according to claim 6, wherein the threads arranged at the flange or the hexagon of the threaded sleeve and matching to the internal threads of the covering cap each are arranged in rounded corner sections of the flange or hexagon and are interrupted at a perimeter by flat sections (9a) of the flange or hexagon.

11. A threaded cable connection according to claim 1, wherein the penetrating opening (11) of the covering cap (10) for the cable (7) and the cable (7) guided through it have a tight tolerance in reference to each other.

12. A threaded cable connection according to claim 1, wherein at the penetrating opening (11) of the covering cap (10) for the cable (7), a gasket (15) made from a flexible material is arranged, with a passage defined in the gasket being smaller than a cross-section of the cable (7) and that the gasket (15) is deformable by the cable guided through it, can be bulged or stretched in an area of the penetrating opening.

13. A threaded cable connection according to claim 1 wherein the covering cap (10) at the penetrating opening (11) for the cable (7) has at least one predetermined breaking point (16) arranged concentrically in reference to the penetrating opening (11), and the penetrating opening (11) can be enlarged by breaking out a part or a circular piece around the penetrating opening (11).

14. A threaded cable connection according to claim 1, wherein corner measures of an exterior polygon or hexagon (17) located at the counter sleeve or union nut (6) are smaller than the flange (9) of the threaded sleeve (4) provided with an external thread (14).

15. A threaded cable connection according to claim 14, wherein corner sections of the exterior polygon or hexagon (11) of the union nut (6) have flattened sections or are reduced, and the flattened sections of the polygon or hexagon match a same wrench size as the flange of the threaded sleeve.

16. A threaded cable connection according to claim 1, wherein a face (10b) of the covering cap (10) pointing away from the penetrating opening (11) for the cable (7) has an enlarged size in reference to an exterior of the covering cap (10) so that at the face (10b), a seal (12) can be placed or a seal (12) is connected in one piece with the face (10b) of the covering cap (10).
